(19) United States
(12) Patent Application Publication
(10) Pub. No.: US 2026/0270599 A1
(43) Pub. Date: Sep. 10, 2026

(54) EARPHONE AND EARPHONE SYSTEM

(71) Applicant: Beijing Zitiao Network Technology Co., Ltd., Beijing (CN)

(72) Inventors: Zhiyu SUN, Beijing (CN); Xudong LU, Beijing (CN); Jianhui HUANG, Beijing (CN); Yaming YANG, Beijing (CN)

(21) Appl. No.: 19/343,249

(22) Filed: Sep. 29, 2025

(30) Foreign Application Priority Data
Mar. 4, 2025 (CN) 202510252544.5

(51) Int. Cl. H04R 1/10

(52) U.S. Cl. CPC H04R 1/1016; H04R 1/1041; H04R 1/105; H04R 1/1066; H04R 1/1083; H04R 2201/107; H04R 2420/07

(57) ABSTRACT

The present application provides an earphone and an earphone system, where the earphone includes a sound emitting part, a main body part and an ear hanging part connecting the sound emitting part and the main body part; wherein the sound emitting part includes a first housing, a camera apparatus and a control module, where the first housing is provided with a visual field hole, and the camera apparatus is arranged at the visual field hole, ; the control module includes a main board, an image processing unit and a main control unit, where the main board includes a first board body, a second board body and a flexible connecting board which are connected in sequence; the image processing unit is arranged on the first board body; and the main control unit is arranged on the second board body.

### CROSS-REFERENCE TO RELATED APPLICATIONS

The present application is based on and claims priority to China Patent Application No. 202510252544.5 filed on Mar. 4, 2025, the disclosure of which is incorporated by reference herein in its entirety.

### TECHNICAL FIELD

The present application relates to an earphone and an earphone system.

### BACKGROUND

Earphones have been widely used in people's daily life, and they can be used with electronic devices such as mobile phones and computers. According to the way users wear earphones, earphones can generally be divided into open earphones and in-ear earphones.

### SUMMARY

The present application provides an earphone, including a sound emitting part for wearing on a front side of an ear, a main body part for wearing on a back side of the ear, and an ear hanging part connecting the sound emitting part and the main body part, wherein the sound emitting part includes a first housing, a speaker unit, a microphone unit, a camera apparatus and a control module, wherein the speaker unit, the microphone unit, the camera apparatus and the control module are arranged in an inner cavity of the first housing, the first housing is provided with a visual field hole, the camera apparatus is arranged at the visual field hole, and the camera apparatus is configured to be capable of shooting an area in front of a human face when the earphone is in a wearing state, the control module includes a main board, an image processing unit and a main control unit, wherein the main board includes a first board body, a second board body and a flexible connecting board which are connected in sequence, and the flexible connecting board is bendable to make the first board body and the second board body be arranged at an included angle, and the image processing unit is arranged on the first board body, the image processing unit is electrically connected to the camera apparatus to process image data shot by the camera apparatus, and the main control unit is arranged on the second board body.

In some embodiments, the camera apparatus is on a front side of the main board in a direction of a sagittal axis of a human body.

In some embodiments, the first board body is on a side of the second board body away from the human face in a direction of a coronal axis of the human body.

In some embodiments, the first board body includes a first surface away from the human face in the direction of the coronal axis of the human body and a second surface close to the human face, the image processing unit is arranged on the first surface, and the second surface is provided with a first connector, and the camera apparatus is connected to the first connector.

In some embodiments, the second board body includes a third surface away from the human face in the direction of the coronal axis of the human body and a fourth surface close to the human face, the main control unit is arranged on the fourth surface.

In some embodiments, the earphone further includes: a voice noise reduction processing unit arranged on the second board body.

In some embodiments, the voice noise reduction processing unit is arranged on the fourth surface of the second board body, and in the direction of the sagittal axis of the human body, the voice noise reduction processing unit is on a front side of the main control unit.

In some embodiments, the first housing is provided with a touch part, wherein the touch part is on a side of the first housing away from the human face in the direction of the coronal axis of the human body; the control module further includes a touch circuit board, wherein the touch circuit board is a flexible circuit board, and the touch circuit board includes a first touch connecting portion and a second touch connecting portion, wherein the first touch connecting portion is on a side of the first board body away from the human face to connect the touch part, and the second touch connecting portion bypasses the first board body to connect the second board body.

In some embodiments, the control module further includes an antenna circuit board, wherein the antenna circuit board is provided with a communication antenna, the antenna circuit board is a flexible circuit board, and the antenna circuit board includes a communication main body and an antenna connecting portion, wherein the communication main body is on a side of the first board body away from the human face, and the antenna connecting portion bypasses the first board body and is connected to the second board body.

In some embodiments, the speaker unit is on a side of the main board facing the human face in the direction of the coronal axis of the human body, and the speaker unit is arranged opposite to the second board body.

In some embodiments, the speaker unit includes a speaker body and a speaker circuit board, wherein the speaker circuit board is a flexible circuit board, and a first end of the speaker circuit board is connected to the speaker body and a second end of the speaker circuit board is connected to the second board body.

In some embodiments, the earphone further includes a wearing detection apparatus, wherein the wearing detection apparatus is arranged on a side of the speaker body facing the human face and connected to the speaker circuit board, and the wearing detection apparatus is configured to detect whether the earphone is worn on the ear.

In some embodiments, the wearing detection apparatus includes a light distance sensor, the first housing is provided with a sound outlet, the sound outlet is on a side of the speaker unit facing the human face and arranged opposite to the speaker unit, and the light distance sensor detects a light change through the sound outlet to determine whether the earphone is worn on the ear.

In some embodiments, the microphone unit includes a directional microphone module configured to pick up pronunciation of an earphone wearer; the ear hanging part includes a second housing, wherein an inner cavity of the second housing and the inner cavity of the first housing are communicated with each other; and the directional microphone module is arranged at a joint of the first housing and the second housing.

In some embodiments, the touch circuit board further includes a third touch connecting portion extending to the joint of the first housing and the second housing, and the directional microphone module is arranged on the third touch connecting portion.

In some embodiments, the second housing and/or the first housing are provided with a directional sound pickup hole, wherein at least two directional sound pickup holes are provided, and the at least two directional sound pickup holes are on both sides of the directional microphone module in the direction of the sagittal axis of the human body.

In some embodiments, the directional sound pickup hole includes two directional sound pickup holes, wherein: a connecting line of the two directional sound pickup holes passes through the directional microphone module; and/or the connecting line of the two directional sound pickup holes passes through a mouth area.

In some embodiments, the microphone unit further includes an omnidirectional microphone module arranged on one of the first touch connecting portion and the second touch connecting portion.

In some embodiments, the main body part includes a third housing, and a battery apparatus and a battery board which are arranged in the third housing, the ear hanging part includes a second housing and a connecting wire harness penetrating through an inner cavity of the second housing, wherein the inner cavity of the second housing is communicated with the inner cavity of the first housing and an inner cavity of the third housing, the battery apparatus is electrically connected to the battery board, and the battery board is connected to the second board body of the main board through the connecting wire harness.

In a second aspect, the present application provides an earphone system including an earphone case and the earphone.

### BRIEF DESCRIPTION OF THE DRAWINGS

The accompanying drawings, which are incorporated in and constitute a part of this description, illustrate embodiments consistent with this application and together with the description, serve to explain the principles of this application.

FIG. 1 is a schematic structural diagram of an earphone provided in Embodiment 1 of the present application;

FIG. 2 is a schematic view of an internal structure of the earphone provided in Embodiment 1 of the present application from an angle;

FIG. 3 is a schematic diagram of the internal structure of the earphone provided in Embodiment 1 of the present application from another angle;

FIG. 4 is a schematic diagram of the internal structure of the earphone provided in Embodiment 1 of the present application from still another angle;

FIG. 5 is an exploded view of the earphone provided in Embodiment 1 of the present application;

FIG. 6 is a structural schematic diagram of a main part of the earphone provided in Embodiment 1 of the present application;

FIG. 7 is a schematic structural diagram of an earphone provided in Embodiment 2 of the present application;

FIG. 8 is an exploded view of the earphone provided in Embodiment 2 of the present application;

FIG. 9 is a schematic structural view of a main board provided by the embodiment of the present application from an angle;

FIG. 10 is a schematic structural view of the main board provided by the embodiment of the present application from another angle;

FIG. 11 is a schematic diagram of an earphone provided in Embodiment 3 of the present application;

FIG. 12 is a schematic diagram of the earphone of this embodiment worn on the ear;

FIG. 13 is a schematic diagram of the ear structure.

### REFERENCE NUMERALS

100—earphone;
10—sound emitting part;
11—first housing; 12—speaker unit; 121—speaker body; 122—speaker circuit board;
13—microphone unit; 131—directional microphone module; 132—omnidirectional microphone module;
14—camera apparatus;
15—control module;
151—main board; 1511—the first board body; 1512—first surface; 1513—second surface; 1514—second board body; 1515—third surface; 1516—fourth surface; 1517—flexible connecting board;
152—image processing unit; 1521—first shield;
153—main control unit; 1531—second shield;
154—voice noise reduction processing unit;
155—touch circuit board; 1551—first touch connecting portion; 1552—second touch connecting portion; 1553—third touch connecting portion;
156—antenna circuit board; 1561—communication main body; 1562—antenna connecting portion;
157—wearing detection apparatus;
161—first connector; 162—second connector; 163—third connector; 164—fourth connector;
20—ear hanging part; 21—second housing; 22—connecting wire harness;
30—main body part; 31—third housing; 32—battery apparatus; 33—battery board;
200—ear; 210—helix; 212—incisura supratragica; 220—concha; 221—concha cavity; 222—cymba concha; 230—tragus; 240—antitragus; 250—antihelix; 251—upper crus of antihelix; 252—lower crus of antihelix; 260—triangular fossa; 270—crus of helix; 280—ear canal opening; 290—earlobe.

Through the above drawings, a clear embodiment of the present application has been shown, which will be described in more detail later. These drawings and written descriptions are not intended to limit the scope of the concept of the present application in any way, but to explain the concept of the present application to those skilled in the art by referring to specific embodiments.

### DETAILED DESCRIPTION

Reference will now be made in detail to exemplary embodiments, examples of which are illustrated in the accompanying drawings. When the following description refers to the drawings, unless otherwise indicated, the same numerals in different drawings indicate the same or similar elements. The embodiments described in the following exemplary embodiments do not represent all embodiments consistent with this application. Rather, they are merely examples of devices and methods consistent with some aspects of the present application as detailed in the appended claims.

Earphones have been widely used in people's daily life, and they can be used with electronic devices such as mobile phones and computers. According to the way users wear earphones, they can generally be divided into open earphones and in-ear earphones. At present, the main functions of most models of earphones are audio playback and voice communication, and there are few types of functions, which are difficult to meet the growing demand of users. Moreover, the internal space of earphones is limited. If it is necessary to increase functions, it is necessary to increase components related to functions.

In view of this, the embodiment of the present application provides an earphone and an earphone system, so that the earphone has an image shooting function, and has an appropriate internal layout.. By arranging a camera apparatus, the earphone has an image shooting function, which is convenient for users to shoot and record. Compared with the integrated arrangement of the image processing unit and the main control unit on a circuit board, that the image processing unit for processing image data is arranged on the first board body of the main board and the main control unit is arranged on the second board body, can reduce the influence of the camera apparatus and the image processing unit on other functional components in the earphone including the main control unit, which is beneficial to simplifying the layout of the circuit and electronic components of the main board. In addition, the first board body and the second board body are connected through the flexible connecting board, which on one hand, achieves the connection interaction between the image processing unit and the main control unit, and on the other hand, the included angle between the first board body and the second board body can be flexibly adjusted according to the space of the sound emitting part to optimize the overall layout so as to improve the space utilization rate and reduce the volume of the sound emitting part as much as possible for the convenience of wearing by users.

In order to clearly describe the structure of the earphone provided by this application, the structure of the ear and the wearing state involved in the text, the front side, back side, upper side and lower side of the ear, sagittal plane, coronal plane, horizontal plane, sagittal axis, coronal axis and vertical axis of the human body will be described below.

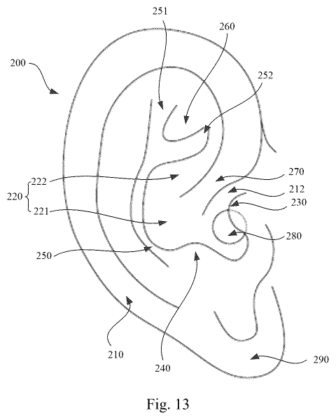

Referring to FIG. 13, ear 200 may include helix 210, incisura supratragica 212, concha 220, tragus 230, antitragus 240, antihelix 250, upper crus of the antihelix 251, lower crus of the antihelix 252, triangular fossa 260, crus of helix 270, ear canal opening 280 and earlobe 290. The concha 220 may include cymba concha 222 and concha cavity 221.

Front and back sides of the ear are defined as follows: the “front side of the ear” mentioned in this application is a concept relative to the “back side of the ear”, the former refers to the side of the ear facing away from the head, the latter refers to the side of the ear facing the head, the “upper edge of the ear” refers to the outer edge of the ear with the helix facing upwards, and the “lower edge of the ear” refers to the outer edge of the ear with the helix facing downwards, both of which are in regard with the user's ear.

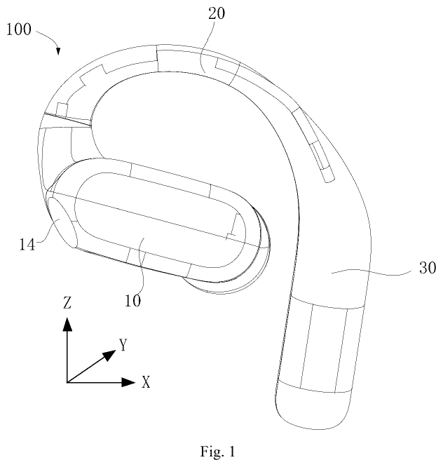

Sagittal plane, coronal plane, horizontal plane, sagittal axis, coronal axis and vertical axis of a human body are defined as follows: as commonly known, in the fields of medicine, anatomy and so on, three basic sections of a human body, namely sagittal plane, coronal plane and horizontal plane, and three basic axes, namely sagittal axis, coronal axis and vertical axis can be defined. Sagittal plane refers to the section perpendicular to the ground along the front-back direction of the body, which divides the human body into left and right parts; coronal plane refers to the section perpendicular to the ground along the left-right direction of the body, which divides the human body into front and back parts; the horizontal plane refers to the section parallel to the ground along the up-down direction of the body, which divides the human body into upper and lower parts. Accordingly, the sagittal axis refers to the axis that vertically passes through the coronal plane along the front-back direction of the body (X direction as shown in FIGS. 1-3) , the coronal axis refers to the axis that vertically passes through the sagittal plane along the left-right direction of the body (Y direction as shown in FIGS. 1-3) , and the vertical axis refers to the axis that vertically passes through the horizontal plane along the up-down direction of the body (Z direction as shown in FIGS. 1-3) .

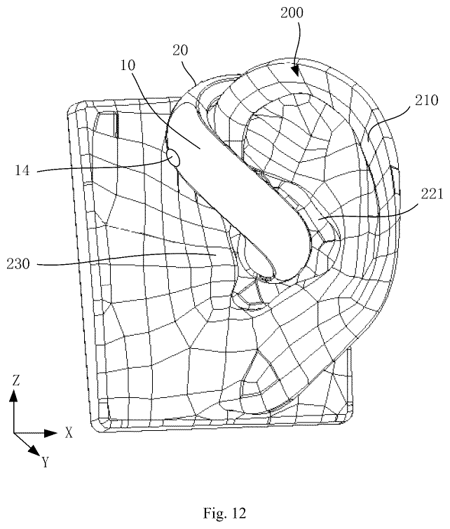

Hereinafter, an earphone 100 according to the embodiment of a first aspect of the present application will be described with reference to FIGS. 1 to 13.

The earphone 100 of the embodiment of the present application may be an ear-hanging earphone. The earphone 100 may include a sound emitting part 10, a main body part 30 and an ear hanging part 20.

Specifically, as shown in FIG. 12, the sound emitting part 10 is configured for sounding. In the wearing state, the sound emitting part 10 is on the front side of the ear, and a part of the sound emitting part 10 can extend into the concha cavity 221, while another part of the sound emitting part 10 extends obliquely forward and upward from the incisura supratragica 212 to the upper side of the tragus 230 and the area in front of the ear 200, so as to facilitate the connection with the ear hanging part 20. The main body part 30 is configured to be worn on the back side of the ear, and can be balanced with the sound emitting part 10, so that the earphone 100 can be better worn on the ear; one end of the ear hanging part 20 is connected to the main body part 30, and the end of the ear hanging part 20 away from the main body part 110 bypasses the top of the helix 210 of the ear part 200, and extends towards the front side of the ear 200 and the upper side of the tragus 230 to connect with the sound emitting part 10, so that a complete and wearable earphone 100 can be formed.

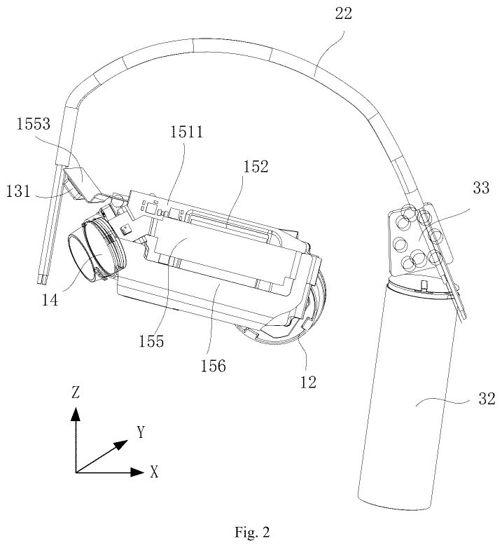

Referring to FIGS. 2-5, the sound emitting part 10 can include a first housing 11 and functional components such as a speaker unit 12, a microphone unit 13, a camera apparatus 14 and a control module 15. The first housing 11 can be designed adaptively according to the ear structure, and the first housing 11 is configured for accommodating functional components such as the speaker unit 12, the microphone unit 13, the camera apparatus 14 and the control module 15. The speaker unit 12 is mainly configured to convert an electrical signal into a sound signal, so as to output audio to the earphone wearer and implement the broadcasting function of the earphone 100. The speaker unit 12 is in the concha cavity 221 and is arranged opposite to the ear canal opening 280. The microphone unit 13 can be configured to capture the sound emitted by the earphone wearer, and convert the sound signal into an electrical signal, so as to facilitate transmission to another device, thereby implementing functions such as voice control or voice communication.

In some embodiments, in order to facilitate the speaker unit 12 to extend into the concha cavity 221, the first housing 11 of the sound emitting part 10 can be provided with a convex structure, and the speaker unit 12 is arranged in an inner cavity of the convex structure, wherein the convex structure is in the concha cavity 221 of the ear and at least partially within the tragus 230 of the ear 200 in the wearing state; in some embodiments, the convex structure is completely within the tragus 230. In this way, the speaker unit 12 can be made closer to the ear canal opening 280, and the performance effect of the sound quality and volume of the earphone 100 is improved. On the premise of ensuring that the speaker unit 12 is as close to the ear canal opening 280 as possible, it will not extend into the ear canal, which can reduce the pressure on and damage to the ear canal and is suitable for wearing for a long time.

The first housing 11 is provided with a visual field hole, and the camera apparatus 14 is arranged at the visual field hole. The camera apparatus 14 is configured to be capable of shooting an area in front of a human face when the earphone 100 is in a wearing state, so as to shoot image data such as videos and photos. In this way, when the earphone 100 is worn, it can directly capture the area in front of the user's face through the visual field hole, and obtain the image or video information in the direction of the user's line of sight.

Exemplarily, the earphone 100 of this embodiment can be configured for daily office, teleconferencing, online education, outdoor hiking and other scenes suitable for recording with a camera apparatus 14. For example, in teleconferencing, the earphone 100 can capture the user's voice and gesture information and provide accurate command input for AI; in online education, the earphone 100 can record students' learning status and progress online to improve personalized education; when hiking in the wild, the earphone 100 can capture the environment or weather information, shooting environment, etc. in real time, and achieve the user's field safety and information reserve. In some embodiments, the camera apparatus 14 in the earphone 100 of this embodiment can further be provided with privacy protection to control the opening and closing time of the camera, and to limit the scope and objects of data transmission to ensure the privacy safety of users.

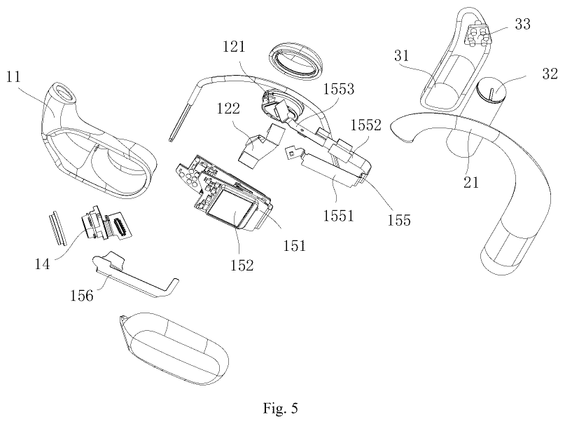

With reference to FIG. 5 and FIGS. 8-10, the control module 15 may include a main board 151, an image processing unit 152 and a main control unit 153, where the main board 151 includes a first board body 1511, a second board body 1514 and a flexible connecting board 1517, where the flexible connecting board is a flexible printed circuit board (FPC). The first board body 1511 and the second board body 1514 can be circuit boards with rigid structures, that is, the first board body 1511 and the second board body 1514 are hard circuit boards with certain structural strength and are not easily deformed. For example, the first board body 1511 and the second board body 1514 can be selected from a printed circuit board (PCB), a ceramic circuit board, an alumina ceramic circuit board, an aluminum nitride ceramic circuit board, an aluminum substrate, a high-frequency board, a thick copper plate, an impedance board, an ultra-thin circuit board or other circuit boards.

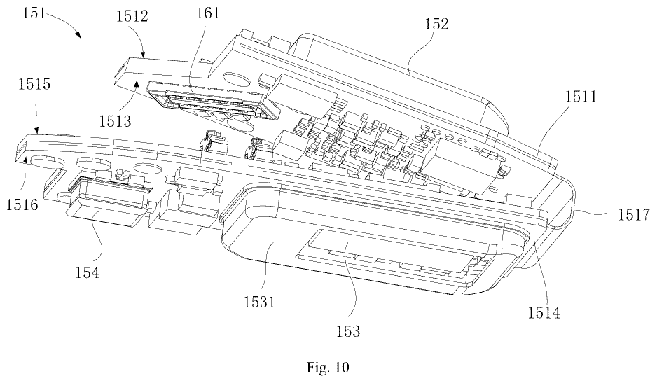

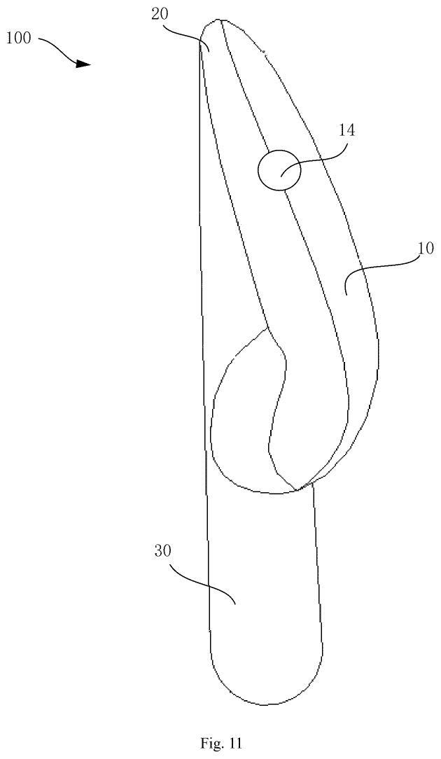

With reference to FIGS. 9 and 10, the first board body 1511 and the second board body 1514 are connected by the flexible connecting board 1517. The flexible connecting board 1517 is flexible, and it can be bent and deformed to a certain extent, so that the first board body 1511 and the second board body 1514 can be arranged at an included angle by bending the flexible connecting board 1517 in a case where the space of the first housing 11 of the sound emitting part 10 is limited.

The image processing unit 152 is arranged on the first board body 1511, and the image processing unit 152 is electrically connected to the camera apparatus 14. The image processing unit 152 can be configured to process the image data shot by the camera apparatus 14, so that the earphone 100 can send the image data to other matching electronic devices.

The main control unit 153 is arranged on the second board body 1514, and the main control unit 153 can be configured for controlling the earphone 100. For example, the main control unit 153 can be configured for switching the earphone 100, controlling the volume, pausing and continuing playing, and interacting with various functional modules including the image processing unit 152. In some embodiments, the main control unit 153 may be a microcontroller unit (MCU).

The earphone 100 of the embodiment of the present application is provided with the camera apparatus 14, so that the earphone 100 has an image shooting function, which is convenient for users to shoot and record. Compared with the integrated arrangement of the image processing unit 152 and the main control unit 153 on a circuit board, that the image processing unit 152 for processing image data is arranged on the first board body 1511 of the main board 151 and the main control unit 153 is arranged on the second board body 1514, can reduce the influence of the camera apparatus 14 and the image processing unit 152 on other functional components in the earphone 100 including the main control unit 153, which is beneficial to simplifying the layout of the circuit and electronic components of the main board 151. In addition, the first board body 1511 and the second board body 1514 are connected through the flexible connecting board 1517, which on one hand, achieves the connection interaction between the image processing unit 152 and the main control unit 153, and on the other hand, the included angle between the first board body 1511 and the second board body 1514 can be flexibly adjusted according to the space of the sound emitting part 10, to optimize the overall layout so as to improve the space utilization rate and reduce the volume of the sound emitting part 10 as much as possible for the convenience of wearing by users.

In some embodiments, the included angle between the first board body 1511 and the second board body 1514 ranges from 0° to 45°. For example, the included angle between the first board body 1511 and the second board body 1514 may be 0°, 5°, 10°, 15°, 20°, 25°, 30°, 35°, 40°, 45°. The included angle here refers to an included angle formed under the restriction of the space and shape of the first housing 11 after the first board body 1511 and the second board body 1514 are assembled into the first housing 11. In some cases, the first board body 1511 and the second board body 1514 may be arranged in parallel and oppositely, or the first board body 1511 and the second board body 1514 may form any included angle within the above range. Thus, the internal space occupied by the main board 151 can be reduced as much as possible.

In some embodiments, referring to FIG. 9 and FIG. 10, the flexible connecting board 1517 can include a first connecting area, a second connecting area and a transition connecting area. The first board body 1511 is provided with a first clamping groove in the middle along its own thickness direction, and the first connecting area is clamped in the first clamping groove. Thus, on one hand, a connecting area between the first connecting area and the first board body 1511 can be increased to improve the connection stability between the first connecting area and the first board body 1511. On the other hand, two surfaces of the first board body 1511 are on both sides of the first connection area, so that electronic devices can be arranged on both surfaces of the first board body 1511, and more electronic devices can be arranged on the first board body 1511 to integrate more functions.

The second board body 1514 is provided with a second clamping groove in the middle along its own thickness direction, and the second connecting area is clamped in the second clamping groove, and the transition connecting area is adapted for deformation, so that, on one hand, a connecting area between the second connecting area and the second board body 1514 can be increased to improve the connection stability between the second connecting area and the second board body 1514, and on the other hand, the two surfaces of the second board body 1514 are at both sides of the second connecting area, so that electronic devices can be arranged on both surfaces of the second board body 1514, and more electronic devices can be arranged on the second board body 1514 to integrate more functions.

Further, based on the connection manner of the first board body 1511 and the second board body 1514 with the flexible connecting board 1517, electronic devices can be arranged on both surfaces of the first board body 1511 and both surfaces of the second board body 1514, so that when the first board body 1511 and the second board body 1514 form an included angle, electronic devices with smaller volume and electronic devices for interactive connection of the two boards (i.e., the first board body 1511 and the second board body 1514) may be arranged on the side surfaces of the first board body 1511 and the second board body 1514 facing each other, thereby simplifying the circuit structure of the main board 151.

In some embodiments, the camera apparatus 14 is on the front side of the main board 151 along the sagittal axis of the human body. Since the main board 151 usually occupies the main space in the inner cavity of the sound emitting part 10, the camera apparatus 14 is arranged on the front side of the main board 151, which is convenient for putting the camera apparatus 14 in front and shooting the area in front of the human face. At the same time, the main board 151 can be arranged in a larger space on the back side of the camera apparatus 14, which can achieve an appropriate layout of various functional components in the sound emitting part 10.

With reference to FIG. 9 and FIG. 10, considering that when the camera apparatus 14 shoots forward, there is usually a blind area caused by human face occlusion, in order to narrow the scope of the blind area, the camera apparatus 14 needs to be arranged as away from the human face as possible along the coronal axis of the human body. In this regard, arranging the first board body 1511 on the side of the second board body 1514 away from the human face along the coronal axis of the human body can make the distance between the camera apparatus 14 and the first board body 1511 closer and facilitate the connection and assembly of the camera apparatus 14 with the first board body 1511 and the image processing unit 152.

Understandably, the visual field hole can be opened in the part of the first housing 11 of the sound emitting part 10 that extends to the front side of the ear 200 and the upper side of the tragus 230, so that the camera apparatus 14 is closer to the front of the human face to further reduce the shooting blind area of the camera apparatus 14. Here, the main board 151 and the tragus 230 face each other in the direction of the coronal axis of the human body, so as to minimize the distance between the first board body 1511 of the main board 151 and the camera apparatus 14 and reduce the volume of the sound emitting part 10.

Further, with reference to FIGS. 9 and 10, the first board body 1511 may include a first surface 1512 and a second surface 1513, where the first surface 1512 is a surface of the first board body 1511 that is away from the human face along the coronal axis of the human body, and the second surface 1513 is a surface of the first board body 1511 that is close to the human face along the coronal axis of the human body, in other words, the first surface 1512 is a surface of the first board body 1511 that faces away from the second board body 1514, and the second surface 1513 is actually a surface of the first board body 1511 facing the second board body 1514. The image processing unit 152 is disposed on the first surface 1512, and the second surface 1513 is provided with a first connector 161, the first connector 161, as a connection terminal, is connected to the camera apparatus 14.

Because a volume of the image processing unit 152 is larger than a volume of the first connector 161, the first connector 161 is arranged on the second surface 1513 and the image processing unit 152 is arranged on the first surface 1512, which can avoid occupying more space between the first board body 1511 and the second board body 1514 when the image processing unit 152 is arranged on the second surface 1513. It is beneficial to reduce the distance between the first board body 1511 and the second board body 1514 or the included angle between the first board body 1511 and the second board body 1514, thereby reducing the space occupied by the main board 151 and contributing to the miniaturization design of the sound emitting part 10.

In some embodiments, referring to FIGS. 2 and 3 and FIGS. 9 and 10, the first connector 161 is at the front of the second surface 1513 in the direction of the sagittal axis of the human body. Here, the first connector 161 can correspond to the area outside the tragus 230, so that the distance between the first connector 161 and the camera apparatus 14 can be closer, thus shortening a length of a connecting line between the camera apparatus 14 and the first connector 161, which is beneficial to further saving space.

In some embodiments, referring to FIG. 9 and FIG. 10, the second board body 1514 may include a third surface 1515 and a fourth surface 1516, where the third surface 1515 is a surface of the second board body 1514 that is away from the human face in the direction of the coronal axis of the human body, and the fourth surface 1516 is a surface of the second board body 1514 that is close to the human face in the direction of the coronal axis of the human body. In other words, the third surface 1515 is a surface of the second board body 1514 facing the first board body 1511, the third surface 1515 is opposite to the second surface 1513 of the first board body 1511, and the fourth surface 1516 is a surface of the second board body 1514 facing away from the first board body 1511. The main control unit 153 is disposed on the fourth surface 1516.

Because the main control unit 153 has a large volume, arranging the main control unit 153 on the fourth surface 1516 can avoid occupying more space between the first board body 1511 and the second board body 1514 when the main control unit 153 is arranged on the third surface 1515, which is beneficial to reducing the distance between the first board body 1511 and the second board body 1514 or the included angle between the first board body 1511 and the second board body 1514, thereby reducing the space occupied by the main board 151 and contributing to the miniaturization design of the sound emitting part 10.

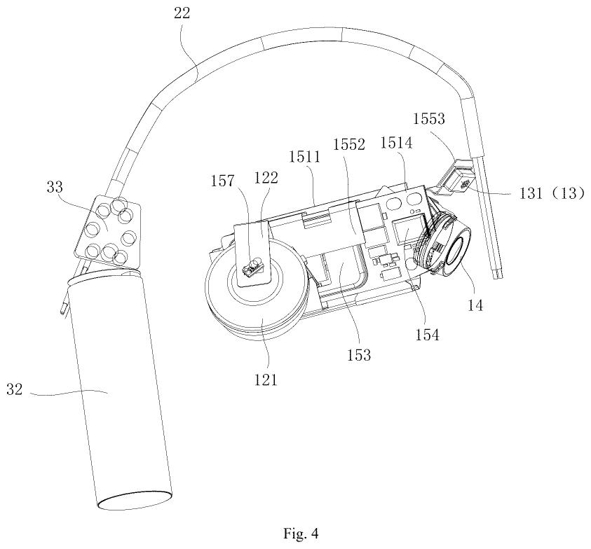

In some embodiments, referring to FIGS. 4, 9 and 10, the earphone 100 may further include a voice noise reduction processing unit 154 arranged on the second board body 1514. For example, the voice noise reduction processing unit 154 can be a bone voiceprint sensor, that is, a voice pickup unit (VPU). The voice processing unit can identify and process the vibration generated when the earphone wearer utters, that is, capture the voice signal through bone conduction. Compared with the traditional air conduction microphone, it can more effectively isolate the environmental noise and improve the clarity and purity of the voice. In some embodiments, the wearer can issue an instruction to enable camera shooting as needed when wearing, and the voice noise reduction processing unit 154 recognizes and processes the voice signal after acquiring the voice signal, so as to start the camera apparatus 14. Of course, the function of the voice noise reduction processing unit 154 is only given as an example, which is not limited here in this embodiment.

In this embodiment, the voice noise reduction processing unit 154 is arranged on the second board body 1514, which facilitates the interaction between the voice noise reduction processing unit 154 and the main control unit 153, and also reduces the influence of the voice noise reduction processing unit 154 on the layout of the image processing unit 152.

In some embodiments, the voice noise reduction processing unit 154 is arranged on the fourth surface 1516 of the second board body 1514, that is, the voice noise reduction processing unit 154 and the main control unit 153 are on the same side of the second board body 1514, so that the voice noise reduction processing unit 154 is closer to the human face in the direction of the coronal axis of the human body, and it is easier to feel the vibration generated when the wearer pronounces.

Further, in the direction of the sagittal axis of the human body, the voice noise reduction processing unit 154 is on the front side of the main control unit 153, so that the voice noise reduction processing unit 154 is closer to the mouth of the wearer, which is beneficial to making the picked-up voice information clearer and reducing the environmental noise.

In some embodiments, because the voice noise reduction processing unit 154 works by feeling the head vibration of the wearer when pronouncing, the first housing 11 and the second board body 1514 of the sound emitting part 10 can be extended to the area above the tragus 230 and in front of the ear 200, and the voice noise reduction processing unit 154 can be arranged in the area of the second board body 1514, so as to ensure that the part where the voice noise reduction processing unit 154 is can contact the human face, not the ear, which is beneficial to shortening the vibration transmission path and further improving the detection accuracy of the voice noise reduction processing unit 154. The main control unit 153 can be in the area opposite to the tragus 230 of the second board body 1514 to avoid interference with the voice noise reduction processing unit 154, which is beneficial to optimizing the layout.

In some embodiments, referring to FIG. 5 and FIGS. 8-10, the first housing 11 is further provided with a touch part, which can be a touch screen, a touch button or the like, and the wearer can control the earphone 100 through the touch part. The touch part is on a side of the first housing 11 away from the human face in the direction of the coronal axis of the human body. The control module 15 may further include a touch circuit board 155. Specifically, the touch circuit board 155 is a flexible circuit board (FPC), and the touch circuit board 155 includes a first touch connecting portion 1551 and a second touch connecting portion 1552. The first touch connecting portion 1551 is on the side of the first board body 1511 away from the human face, so it is convenient to connect the first touch connecting portion 1551 with the touch part, the second touch connecting portion 1552 bypasses the first board body 1511 to connect the second board body 1514, and the touch circuit board 155 can connect the touch part to the main board 151 so as to facilitate the main control unit 153 on the main board 151 to process the operation instructions of the wearer.

In some embodiments, the second touch connecting portion 1552 can bypass the first board body 1511 from one side of the first board body 1511 in the direction of the vertical axis of the human body or from one side of the first board body 1511 in the direction of the sagittal axis of the human body, which is not limited in this embodiment.

In some embodiments, referring to FIGS. 9 and 10, the third surface 1515 is provided with a second connector 162, the second connector 162 is connected to the second touch connecting portion 1552, that is, the second touch connecting portion 1552 extends between the first board body 1511 and the second board body 1514 after bypassing the first board body 1511, and is connected to the second connector 162 on the second board body 1514. In this way, the space between the first board body 1511 and the second board body 1514 can be fully utilized, and the space utilization rate of the sound emitting part 10 can be improved.

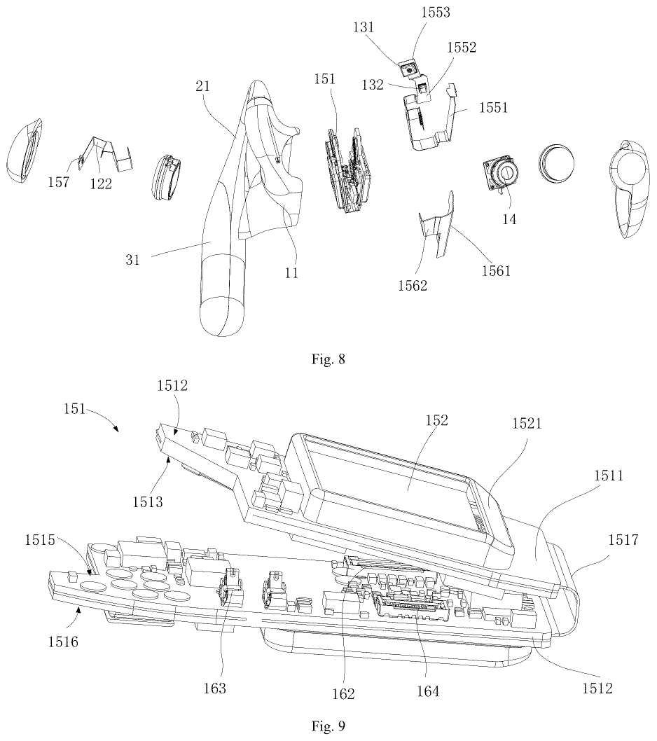

In some embodiments, referring to FIGS. 5 and 8, the control module 15 may further include an antenna circuit board 156. Specifically, the antenna circuit board 156 is provided with a communication antenna, and here, the antenna circuit board 156 can be used as a communication device of the earphone 100. The antenna circuit board 156 is a flexible circuit board (FPC), and the antenna circuit board 156 may include a communication main body 1561 and an antenna connecting portion 1562, where the communication main body 1561 is a part of the antenna circuit board 156 that mainly forms a communication circuit or a radio frequency circuit, and the communication main body 1561 is on the side of the first board body 1511 away from the human face, which is beneficial to reducing the mutual interference between the antenna circuit board 156 and an magnet of the speaker unit 12, and also to reducing the human body discomfort caused by the heat generated by the antenna circuit board 156. The antenna connecting portion 1562 bypasses the first board body 1511 and is connected to the second board body 1514. In this way, the antenna circuit board 156 can be connected to the main board 151 under the condition of ensuring the communication function of the antenna circuit board 156, so as to facilitate the communication between the earphone 100 and external electronic device and the processing of communication information by the main board 151.

In some embodiments, the antenna connecting portion 1562 can bypass the first board body 1511 from one side of the first board body 1511 in the direction of the vertical axis of the human body or from one side of the first board body 1511 in the direction of the sagittal axis of the human body, which is not limited in this embodiment. In order to avoid interference between the antenna circuit board 156 and the touch circuit board 155, the second touch connecting portion 1552 and the antenna connecting portion 1562 can bypass the first board body 1511 from different directions of the first board body 1511.

In some embodiments, referring to FIGS. 9 and 10, the third surface 1515 of the second board body 1514 is further provided with a third connector 163, and the third connector 163 is connected to the antenna connecting portion 1562, so that the space between the first board body 1511 and the second board body 1514 can be fully utilized, and the space utilization rate of the sound emitting part 10 can be improved.

In some embodiments, the speaker unit 12 is on a side of the main board 151 facing the human face in the direction of the coronal axis of the human body, so that the speaker unit 12 is closer to the ear, which can reduce the sound wave transmission path and is beneficial to improving the sound quality.

Moreover, the speaker unit 12 and the second board body 1514 are arranged opposite to each other, so that the distance between the speaker unit 12 and the main board 151 can be shortened, thereby shortening the length of the connecting line, facilitating the connection between the speaker unit 12 and the main board 151, and facilitating the main control unit 153 to control the operation of the speaker unit 12.

In some embodiments, referring to FIGS. 5, 8 and 9 and 10, the speaker unit 12 may include a speaker body 121 and a speaker circuit board 122, and the speaker body 121 may convert an electrical signal into a sound signal. The speaker circuit board 122 is a flexible circuit board (FPC). A first end of the speaker circuit board 122 is connected to the speaker body 121, and a second end of the speaker circuit board 122is connected to the second board body 1514. In this way, the speaker body 121 can be connected to the main board 151 through the speaker circuit board 122 to implement the control of the speaker unit 12 by the main control unit 153. Moreover, the speaker circuit board 122 is made of a flexible circuit board, which is convenient to bend and deform the speaker circuit board 122 according to the spatial layout in the first housing 11, so as to make the assembly more flexible.

In some embodiments, referring to FIGS. 9 and 10, the third surface 1515 of the second board body 1514 is further provided with a fourth connector 164, and the speaker body 121 can be opposite to the fourth connector 164 in the direction of the coronal axis of the human body, and the second end of the speaker circuit board 122 is connected to the fourth connector 164. In this way, the space between the first board body 1511 and the second board body 1514 can be fully utilized, and the space utilization rate of the sound emitting part 10 can be improved.

In some embodiments, referring to FIGS. 4 and 8, the earphone 100 may further include a wearing detection apparatus 157. Specifically, the wearing detection apparatus 157 is arranged on a side of the speaker body 121 facing the human face and connected to the speaker circuit board 122, and the wearing detection apparatus 157 is configured to detect whether the earphone 100 is worn on the ear. In this way, by arranging the wearing detection apparatus 157, the control module 15 can control the earphone 100 to stop outputting audio when it is detected that the earphone 100 is not worn, thus saving power, and the control module 15 can control the earphone 100 to output audio and execute other control instructions when it is detected that the earphone 100 is worn.

For example, the wearing detection apparatus 157 can be an infrared sensor, a capacitance sensor, a light distance sensor, etc. Taking the infrared sensor as an example, the infrared sensor can emit and receive infrared pulses from a hole structure of the first housing 11. If the infrared pulses reflected by the ear can be received, it can be determined that the earphone 100 is worn, and if the infrared pulses reflected by the ear are not received, it can be determined that the earphone 100 is not worn. Taking the capacitance sensor as an example, if the capacitance sensor is in contact with the skin of the ear, the capacitance sensor can generate an electrical signal, and it is determined that the earphone 100 is worn; if the capacitance sensor does not generate an electrical signal, it is determined that the earphone 100 is not worn. Taking the light distance sensor as an example, if the light distance sensor can receive light from the hole structure of the first housing 11, the hole structure is not blocked, and it can be determined that the earphone 100 is not worn; if the light distance sensor does not receive light from the hole structure of the first housing 11, the hole structure is blocked, and it can be determined that the earphone 100 is worn. Of course, the present application is not limited to this, and the wearing detection apparatus 157 can also be other apparatuses suitable for detecting whether the earphone 100 is worn in place.

In some embodiments, the wearing detection apparatus 157 may be disposed to face the ear canal opening 280, or the wearing detection apparatus 157 may be disposed to face the tragus 230, or the wearing detection apparatus 157 may be disposed to face the concha cavity 221. This application is not limited to this, so that the arrangement forms of the wearing detection apparatus 157 are diversified.

In some embodiments, the wearing detection apparatus 157 may include a light distance sensor, and the first housing 11 is provided with a sound outlet, the sound outlet is on a side of the speaker unit 12 facing the human face, so that when the earphone 100 is worn on the ear, the sound outlet is closer to the ear canal, and the sound outlet may be arranged opposite to the speaker unit 12, and a sound wave generated by the speaker unit 12 can be transmitted to the ear canal through the sound outlet.

The light distance sensor detects a light change through the sound outlet to determine whether the earphone 100 is worn on the ear. In this way, the sound outlet can be used not only for the sound output of the earphone 100, but also for the wearing detection of the light distance sensor, so that a separate opening for the light distance sensor is omitted, which is beneficial to simplifying the manufacturing process of the first housing 11 and reducing the cost.

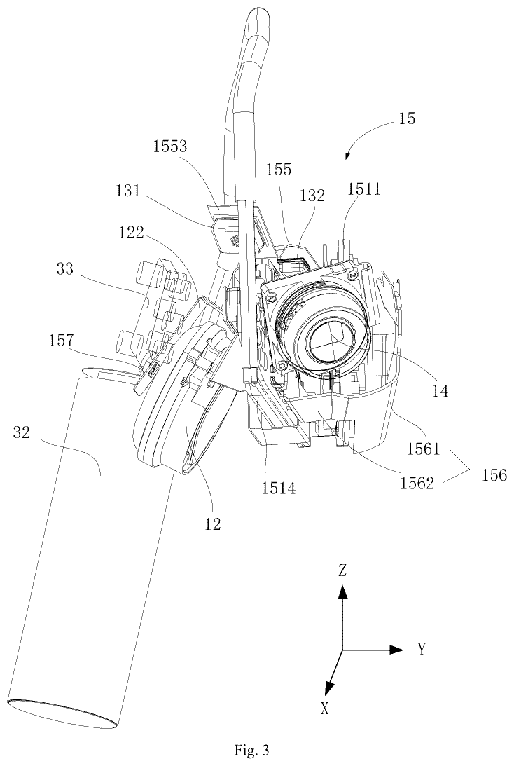

In some embodiments, referring to FIGS. 3 and 4, the microphone unit 13 may include a directional microphone module 131. Specifically, the directional microphone module 131 is configured to pick up the pronunciation of the earphone wearer. The ear hanging part 20 may include a second housing 21, and an inner cavity of the second housing 21 and the inner cavity of the first housing 11 are communicated with each other. For example, the second housing 21 may be a rubber sleeve, a plastic casing or the like.

Considering that when the ear-hanging earphone 100 is worn, the sound emitting part 10 is usually inclined, where a connection position of the sound emitting part 10 and the ear hanging part 20 is at the foremost end of the earphone 100 in the direction of the sagittal axis of the human body. Thus, in this embodiment, the directional microphone module 131 can be arranged at a joint of the first housing 11 and the second housing 21, so that the directional microphone module 131 can be closer to the mouth of the earphone wearer, which is beneficial for the directional microphone module 131 to better pick up and capture the pronunciation of the earphone wearer, improve the pronunciation quality and reduce noise interference.

In some embodiments, referring to FIG. 3 and FIG. 4, the touch circuit board 155 may further include a third touch connecting portion 1553. The third touch connecting portion 1553 extends to the joint of the first housing 11 and the second housing 21, for example, the third touch connecting portion 1553 extends to the upper side of the tragus 230 and the front side of the ear 200, and the directional microphone module 131 is arranged on the third touch connecting portion 1553, so as to shorten the distance between the directional microphone module 131 and the mouth area as much as possible.

In some embodiments, the third touch connecting portion 1553 can be connected to the second touch connecting portion 1552, or to the first touch connecting portion 1551, for example, to the second touch connecting portion 1552, so that the directional microphone module 131 can be powered by the touch circuit board 155, and the distance between the directional microphone module 131 and the main control unit 153 can be made smaller, the signal transmission distance can be shortened, and the sensitivity of the earphone 100 can be improved.

In some embodiments, the second housing 21 and/or the first housing 11 are provided with a directional sound pickup hole, that is, only the first housing 11 is provided with the directional sound pickup hole, only the second housing 21 is provided with the directional sound pickup hole, or both the first housing 11 and the second housing 21 are provided with the directional sound pickup hole. The directional microphone module 131 can pick up the pronunciation of the earphone wearer through the directional pickup hole.

At least two directional sound pickup holes are provided, for example, two directional sound pickup holes or three or more are provided. The at least two directional sound pickup holes are on both sides of the directional microphone module 131 in the direction of the sagittal axis of the human body. Because the distances between the two directional sound pickup holes and the mouth of the earphone wearer are different, the directional microphone module 131 can determine whether it is the pronunciation of the earphone wearer according to a time difference between sound waves picked up from the two directional sound pickup holes, thus filtering out the environmental noise.

In some embodiments, the directional sound pickup hole comprises two directional sound pickup holes, and a connecting line of the two directional sound pickup holes passes through the directional microphone module 131. In this way, after the sound waves emitted by the earphone wearer enter the directional pickup hole, they can all propagate to the directional microphone module 131 along a straight line, which is beneficial to improving the accuracy of the sound wave source judgment result.

In some embodiments, the directional sound pickup hole comprises two directional sound pickup holes, and the connecting line of the two directional sound pickup holes passes through a mouth area, so that the distance between the two directional sound pickup holes and the mouth area can be shortened as much as possible, and it is easier to pick up and capture the pronunciation of the earphone wearer.

In some embodiments, at least two directional sound pickup holes are at the upper side of the tragus 230 and the front side of the ear 200, and are adjacent to an upward edge of the helix 210.

In some embodiments, referring to FIG. 8, the microphone unit 13 may further include an omnidirectional microphone module 132. Specifically, the omnidirectional microphone module 132 may be arranged on one of the first touch connecting portion 1551 and the second touch connecting portion 1552. For example, the omnidirectional microphone module 132 may be arranged on the first touch connecting portion 1551 or the second touch connecting portion 1552. In this way, the touch circuit board 155 can be used to supply power to the omnidirectional microphone module 132 and provide mounting support.

For example, the omnidirectional microphone module 132 can be arranged on the second touch connecting portion 1552, which can make the distance between the omnidirectional microphone module 132 and the main control unit 153 to be smaller, shorten the signal transmission distance and improve the sensitivity of the earphone 100.

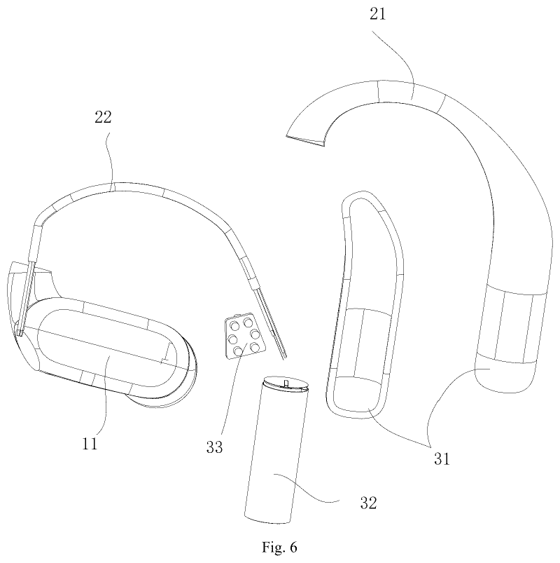

In some embodiments, referring to FIGS. 5 and 6, the main body part 30 may further include a third housing 31, a battery apparatus 32 and a battery board 33. The third housing 31 is on the back side of the ear 200, the battery apparatus 32 and the battery board 33 can be arranged in an inner cavity of the third housing 31, and the ear hanging part 20 can include a second housing 21 and a connecting wire harness 22 penetrating through an inner cavity of the second housing 21, and the inner cavity of the second housing 21 is communicated with the inner cavity of the first housing 11 and the inner cavity of the third housing 31. The battery apparatus 32 is electrically connected to the battery board 33, and the battery board 33 is connected to the main board 151 through the connecting wire harness 22. For example, the battery board 33 can be connected to the second board body 1514 through the connecting wire harness 22, so that the interaction between the battery board 33 and the main board 151 can be achieved, and further the power management, power-on and power-off of the earphone 100 can be achieved.

In some embodiments, a front end of the second board body 1514 extends beyond a front end of the first board body 1511 along the sagittal axis of the human body, and the battery board 33 is connected to a front end of the second board body 1514 through the connecting wire harness 22, which is beneficial to shortening a length of the connecting wire harness 22, saving materials and reducing the cost.

In some embodiments, referring to FIGS. 5 and 6, the battery board 33 is arranged adjacent to a joint of the second housing 21 and the third housing 31. In this way, it is beneficial to shorten the length of the connecting wire harness 22, save materials and reduce the cost.

In some embodiments, referring to FIGS. 9 and 10, the image processing unit 152 can be covered with a first shield 1521, and the main control unit 153 can be covered with a second shield 1531, so that the image processing unit 152 and the main control unit 153 can be prevented from being interfered by external electromagnetic waves.

In some embodiments, with reference to FIGS. 1-6, a projection of the camera apparatus 14 on the sagittal plane of the human body is in front of a projection of the speaker unit 12 on the sagittal plane of the human body. In other words, the camera apparatus 14 and the speaker unit 12 are arranged forth and back in the direction of the sagittal axis of the human body, so that the camera apparatus 14 is arranged forward, which is beneficial to expanding the shooting field of the camera apparatus 14 and reducing the blind area so as to better capture the picture, while the speaker unit 12 can provide clear audio output without being influenced by the camera apparatus 14.

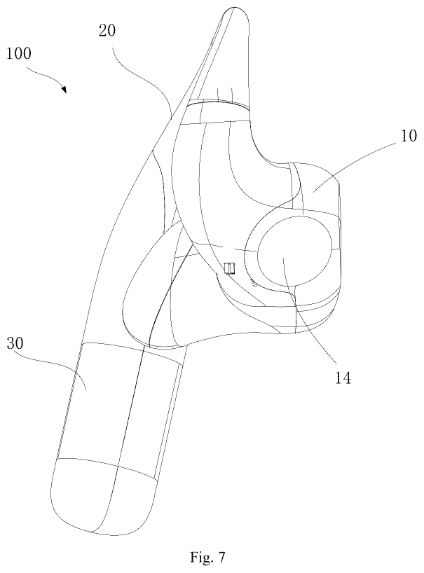

In some embodiments, referring to FIGS. 7 and 8, the projection of the camera apparatus 14 on the sagittal plane of the human body at least partially overlaps with the projection of the speaker unit 12 on the sagittal plane of the human body. In other words, at least part of the camera apparatus 14 and the speaker unit 12 are arranged in the direction of the coronal axis of the human body, so that the camera apparatus 14 is arranged away from the human face, which is beneficial to expanding the shooting field of view of the camera apparatus 14 and reducing the blind area so as to better capture the picture.

Next, an earphone system according to a second embodiment of the present application will be described.

The earphone system of this embodiment may include an earphone case and the earphone 100 of the above embodiment.

Specifically, the earphone case includes a case body and a case cover, where the case body defines an earphone compartment, and the case cover is configured for opening or closing the earphone compartment. The earphone 100 is removably arranged in the earphone compartment, and the earphone case can receive the earphone 100 and charge the earphone 100.

In the earphone system of the embodiment of the present application, by adopting the earphone 100 of the above embodiment, the image shooting function can be implemented, and the shooting requirements of users can be met; moreover, the internal layout of the earphone 100 is optimized, which is convenient for users to wear and use, and is beneficial to improving the user experience.

It can be understood that before using the technical solutions disclosed in various embodiments of this application, users should be informed of the types, application scope and application scenarios of personal information involved in this application in an appropriate way and be authorized by users in accordance with relevant laws and regulations.

For example, in response to receiving the user's active request, prompt information is sent to the user to clearly remind the user that the requested operation will require obtaining and using the user's personal information. Therefore, the user can independently choose whether to provide personal information to software or hardware such as electronic device, applications, servers or storage media that perform the operation of the technical solution of the present application according to the prompt information.

As an optional but non-limiting implementation, in response to receiving the user's active request, the way to send the prompt information to the user can be, for example, a pop-up window, in which the prompt information can be presented in text. In addition, the pop-up window can also carry a selection control for the user to choose “agree” or “disagree” to provide personal information to the electronic device.

It can be understood that the above-mentioned process of notifying and obtaining user authorization is only schematic and does not limit the implementation of this application, and other ways to meet relevant laws and regulations can also be applied to the implementation of this application.

Finally, it should be noted that those skilled in the art will easily think of other embodiments of the present disclosure after considering the description and practicing the present application disclosed here. The present disclosure is intended to cover any variation, use or adaptation of the present application, which follows the general principles of the present application and includes common knowledge or common technical means in the technical field that the present disclosure has not disclosed, and is not limited to the precise structure described above and shown in the drawings, and various modifications and changes can be made without departing from its scope. The scope of the present disclosure is limited only by the appended claims.

What is claimed is

1. An earphone, comprising: a sound emitting part for wearing on a front side of an ear, a main body part for wearing on a back side of the ear, and an ear hanging part connecting the sound emitting part and the main body part,
wherein the sound emitting part comprises a first housing, a speaker unit, a microphone unit, a camera apparatus and a control module, wherein the speaker unit, the microphone unit, the camera apparatus and the control module are arranged in an inner cavity of the first housing, the first housing is provided with a visual field hole, the camera apparatus is arranged at the visual field hole, and the camera apparatus is configured to be capable of shooting an area in front of a human face when the earphone is in a wearing state,
the control module comprises a main board, an image processing unit and a main control unit, wherein the main board comprises a first board body, a second board body and a flexible connecting board which are connected in sequence, and the flexible connecting board is bendable to make the first board body and the second board body be arranged at an included angle, and
the image processing unit is arranged on the first board body, the image processing unit is electrically connected to the camera apparatus to process image data shot by the camera apparatus, and the main control unit is arranged on the second board body.

2. The earphone according to claim 1, wherein the camera apparatus is on a front side of the main board in a direction of a sagittal axis of a human body.

3. The earphone according to claim 2, wherein the first board body is on a side of the second board body away from the human face in a direction of a coronal axis of the human body.

4. The earphone according to claim 3, wherein the first board body comprises a first surface away from the human face in the direction of the coronal axis of the human body and a second surface close to the human face, the image processing unit is arranged on the first surface, and the second surface is provided with a first connector, and the camera apparatus is connected to the first connector.

5. The earphone according to claim 4, wherein the second board body comprises a third surface away from the human face in the direction of the coronal axis of the human body and a fourth surface close to the human face, the main control unit is arranged on the fourth surface.

6. The earphone according to claim 5, further comprising: a voice noise reduction processing unit arranged on the second board body.

7. The earphone according to claim 6, wherein the voice noise reduction processing unit is arranged on the fourth surface of the second board body, and in the direction of the sagittal axis of the human body, the voice noise reduction processing unit is on a front side of the main control unit.

8. The earphone according to claim 3, wherein:
the first housing is provided with a touch part, wherein the touch part is on a side of the first housing away from the human face in the direction of the coronal axis of the human body;
the control module further comprises a touch circuit board, wherein the touch circuit board is a flexible circuit board, and the touch circuit board comprises a first touch connecting portion and a second touch connecting portion, wherein the first touch connecting portion is on a side of the first board body away from the human face to connect the touch part, and the second touch connecting portion bypasses the first board body to connect the second board body.

9. The earphone according to claim 3, wherein the control module further comprises an antenna circuit board, wherein the antenna circuit board is provided with a communication antenna, the antenna circuit board is a flexible circuit board, and the antenna circuit board comprises a communication main body and an antenna connecting portion, wherein the communication main body is on a side of the first board body away from the human face, and the antenna connecting portion bypasses the first board body and is connected to the second board body.

10. The earphone according to claim 3, wherein the speaker unit is on a side of the main board facing the human face in the direction of the coronal axis of the human body, and the speaker unit is arranged opposite to the second board body.

11. The earphone according to claim 10, wherein the speaker unit comprises a speaker body and a speaker circuit board, wherein the speaker circuit board is a flexible circuit board, and a first end of the speaker circuit board is connected to the speaker body and a second end of the speaker circuit board is connected to the second board body.

12. The earphone according to claim 11, further comprising a wearing detection apparatus, wherein the wearing detection apparatus is arranged on a side of the speaker body facing the human face and connected to the speaker circuit board, and the wearing detection apparatus is configured to detect whether the earphone is worn on the ear.

13. The earphone according to claim 12, wherein the wearing detection apparatus comprises a light distance sensor, the first housing is provided with a sound outlet, the sound outlet is on a side of the speaker unit facing the human face and arranged opposite to the speaker unit, and the light distance sensor detects a light change through the sound outlet to determine whether the earphone is worn on the ear.

14. The earphone according to claim 8, wherein:
the microphone unit comprises a directional microphone module configured to pick up pronunciation of an earphone wearer;
the ear hanging part comprises a second housing, wherein an inner cavity of the second housing and the inner cavity of the first housing are communicated with each other; and
the directional microphone module is arranged at a joint of the first housing and the second housing.

15. The earphone according to claim 14, wherein the touch circuit board further comprises a third touch connecting portion extending to the joint of the first housing and the second housing, and the directional microphone module is arranged on the third touch connecting portion.

16. The earphone according to claim 14, wherein the second housing and/or the first housing are provided with a directional sound pickup hole, wherein at least two directional sound pickup holes are provided, and the at least two directional sound pickup holes are on both sides of the directional microphone module in the direction of the sagittal axis of the human body.

17. The earphone according to claim 16, wherein the directional sound pickup hole comprises two directional sound pickup holes, wherein: a connecting line of the two directional sound pickup holes passes through the directional microphone module; and/or the connecting line of the two directional sound pickup holes passes through a mouth area.

18. The earphone according to claim 8, wherein the microphone unit further comprises an omnidirectional microphone module arranged on one of the first touch connecting portion and the second touch connecting portion.

19. The earphone according to claim 3, wherein:
the main body part comprises a third housing, and a battery apparatus and a battery board which are arranged in the third housing,
the ear hanging part comprises a second housing and a connecting wire harness penetrating through an inner cavity of the second housing, wherein the inner cavity of the second housing is communicated with the inner cavity of the first housing and an inner cavity of the third housing,
the battery apparatus is electrically connected to the battery board, and the battery board is connected to the second board body of the main board through the connecting wire harness.

20. An earphone system, comprising: an earphone case and the earphone according to claim 1.
